(19) United States
(12) Patent Application Publication
(10) Pub. No.: US 2002/0059220 A1
(43) Pub. Date: May 16, 2002

(54) Intelligent computerized search engine

(76) Inventor: Edwin Colby Little, Windsor, CO (US)

Correspondence Address: Edwin Little, 917 Shetland Ct., Windsor, CO, 80550, US

(21) Appl. No.: 09/976,691

(22) Filed: Oct. 12, 2001

Related U.S. Application Data
(60) Provisional application No. 60/240,332, filed on Oct. 16, 2000.

(51) Int. Cl. G06F 7/00

(52) U.S. Cl. 707/5

(57) ABSTRACT

A computer program search engine is disclosed which identifies descriptions from a subject database that are conceptually similar to the target input string. The matching is based on a fuzzy logic correlation between the input terms, supplemented by semantically related terms, and each description in the subject database. The semantic relationships and contextual significance of the subject database's core vocabulary is initially generated off-line by manually applying a set of templates to a statistical analysis and sampling of the terminology usage in the descriptions. This data is stored in a look-up table that is used to expand an inputted target set of words and identify the relative importance of each term. Each description is then compared to the expanded target set with each word match extended by its significance factor. The conceptual similarity between a description from the database and an input string is expressed by the sum of all extended matches. Users are presented with the matches in descending order of similarity for entries with positive totals.

### BACKGROUND OF THE INVENTION

1. Field of Invention

This present invention relates to query processing, and more specifically relates to techniques for identifying entries that are conceptually similar to the search criteria.

2. Description of Related Art

With the increasing popularity of the Internet and the World Wide Web, a large number of highly specialized sites have come on line that exclusively address very narrowly defined subject matter. Their applications range from obscure technical disciplines to specialty e-commerce merchants. Most, however, maintain their information in databases that contain descriptive phrases in each record. This architecture allows the sites to provide search engines intended to help on-line users easily locate their desired information.

The vast majority of current search engines are fundamentally based on a direct character string comparison function. When a user submits a query containing one or more query terms, the search engine identifies records that contain character strings that are exact matches to the query terms. While many current search engines supplement this basic functionality with Boolean capabilities and “wildcard” characters, the search itself is precisely literal. An exhaustive set of matching citations is returned for user review. In the hands of a sophisticated user, fluent in the exact terminology of the database, these search engines can efficiently highlight the desired information. Small variations in nomenclature, however, are catastrophic for the underlying matching function. For example, a user seeking information on “bikes” will not be shown references to “bicycles”. As a result, novice users often miss many relevant records due to the limitations of the underlying character string matching function.

An alternative approach to this situation is to force the descriptions and query terms into a standardized set of categories (fields) and entries (allowed terms). The resulting structured query is often executed using “drop down” boxes that limit input to acceptable inputs. This rigid approach has discouraged its use by many novices and still fails to identify matches when the terminology of the database is not intuitively obvious to the casual observer.

In an attempt to allow more natural unstructured user input, a number of search engines have been developed that attempt to search based on the contents, or semantics, of the query. The direct application of this approach has not been successful due to the ambiguous and contextually specific nature of natural language (i.e. “cycling” may refer to riding a bicycle, riding a motorcycle or repeating the same set of actions, depending on the context). Further, these engines remain completely intolerant of the kind of partially incorrect input that is typical of novice users. The proliferation of highly specialized databases, however, offers the opportunity to exploit their coverage of only a very limited domain of information. This allows a minimal vocabulary and a single predominate semantic structure to effectively characterize the content of the domain.

Consequently, the prior art does not provide the novice with a means to intuitively search specialized databases with just a layman's vocabulary and only a partial understanding of the subject matter. This failure has substantial commercial significance for a number of Internet businesses, such as electronic auctions. These businesses cater to a wide variety of consumers that typically include many “novice” users. Given the fiercely competitive nature of the industry, even minor inconveniences in the user interface will move customers from one web business to another (“Your competition is only a click away”) Once a consumer has chosen a web auction, potential buyers and sellers of a particular item must find each other to initiate a negotiation. Given the breadth of items offered at any one time, search engines are typically employed by potential buyers to identify offers of interest. The limitations of existing search engines cause them to miss potential matches and preclude potential sales.

### SUMMARY OF THE INVENTION

To provide a means for a novice user to quickly and easily identify records of interest in a specialized database, without specific knowledge of the covered subject matter.

The present invention achieves this objective with a novel semantic based method of identifying records of interest based on the similarity of their content to the meaning of the input phrase. In accordance with the invention, “expert knowledge” of the content of the database is stored in a computer file, This file's architecture allows a computer program to supplement a user's input with additional information that expresses the meaning of the request more fully in the context of the database. The invention also employs a novel search technique that rates the similarity of each database record to the meaning of the user request. While the resulting search engine accommodates unformatted, a natural language input, it is not dependent on the use of precise terminology. Further, since its fundamental record identification function is based on semantic similarity rather than exact character string matching, the search techniques can tolerate partially incorrect user input.

### BRIEF DESCRIPTION OF THE DRAWINGS

FIG. 1 is a block diagram illustrating the modules of the present invention and how they relate to each other in operation.

FIG. 2 is a flow chart that illustrates the steps performed to identify the core vocabulary of a database.

FIG. 3 is a flow chart that illustrates the steps performed to construct a predominate semantic structure that effectively models the database content.

FIG. 4 is a flow chart that illustrates the steps performed to associate the core vocabulary within the predominate semantic structure.

FIG. 5 is a flow chart that illustrates the steps performed to supplement the core vocabulary and capture the contextual significance of the usage of each term.

FIG. 6 is a flow chart that illustrates the steps performed to interpret the meaning of a user request.

FIG. 7 is a flow chart that illustrates the steps performed to determine the similarity of a database record to the meaning of a user request.

### DETAILED DESCRIPTION OF THE INVENTION

The present invention provides a search methodology that identifies records in a specialized database that have content that is similar to the meaning of a user request.

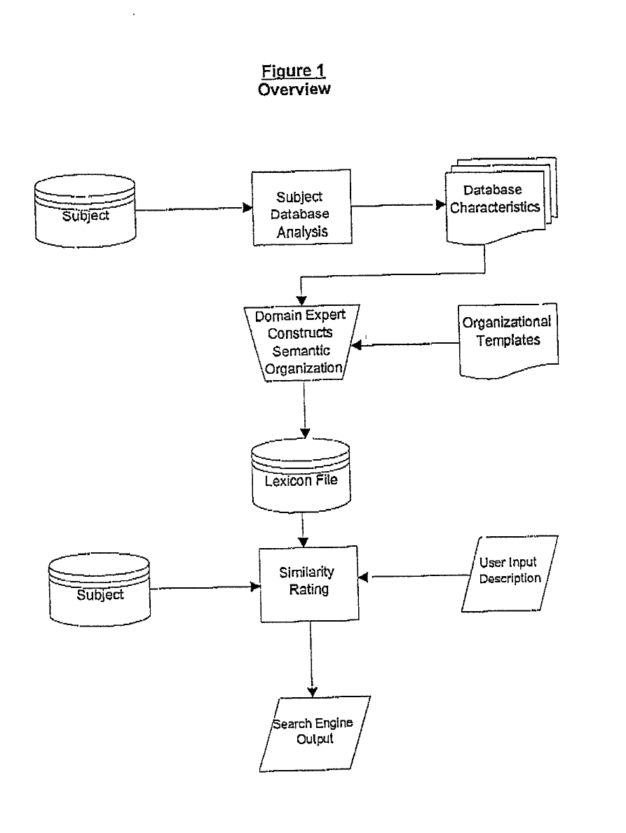

FIG. 1 provides an overview of the invention's process. A sophisticated user of the subject database (the “domain expert”) is presented with computer generated characteristics of the database, along with a number of possible organizational templates. The domain expert then constructs an appropriate semantic organizational structure for the content of the database, The expert also supplements the database's core vocabulary and assigns all terms within the semantic structure, thereby incorporating his domain expertise into the Lexicon file. The information in the Lexicon file is used to supplement a user request, to more fully express it's meaning within the context of the database. The expanded query is then used to rate the similarity of the content of each database record to the meaning of the user request. Entries with high similarity are presented to the user for subjective review.

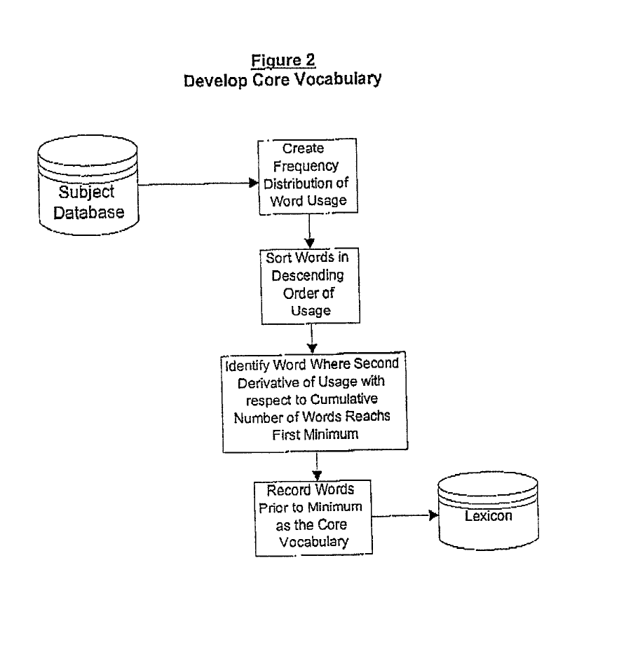

FIG. 2 illustrates how the invention implements Praeto's Principle (the so called “80/20 rule) to identify the database's core vocabulary. The computer program performs a word usage distribution analysis on the entire text of the database, identifying the total number of times each word is used. The computer program then sorts the words in descending order of usage and prepares a matrix that associates the number of times a word is used with the cumulative number of words in the rank ordering prior to that word, The computer program then identifies the first point of inflection of the associated curve by using the technique of Newton's Approximation to identify the first significant local minimum of the second derivative of usage with respect to the cumulative number of words. The computer program then identifies the core vocabulary of the database as the set of words in the matrix prior to the point of inflection.

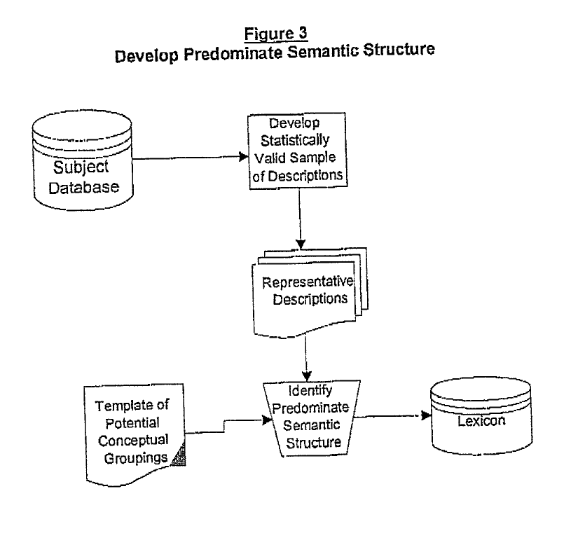

FIG. 3 illustrates how the invention captures the predominate semantic structure of the database. The computer generates a random sample of descriptions from the database that is statistically representative of the population at a 95% confidence level, These descriptions are presented to a domain expert along with a set of possible semantic organizational templates (i.e. potential conceptual groupings of information such as color, size, author, etc.). The domain expert is then asked to construct the predominate semantic structure of the database by identifying the primary conceptual groupings that are repeatedly used through out the descriptions. The domain expert is also asked to assign each conceptual grouping an importance (high, medium, low or none) as it relates to the content of a description. [For example, the brand is more important in a description of a bicycle than its color is.] These groupings and their importance are recorded in the Lexicon file.

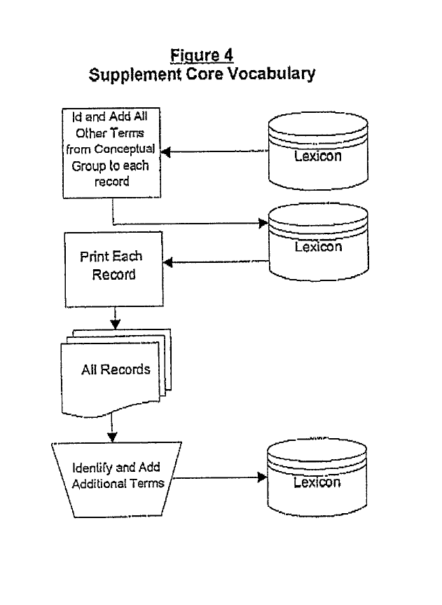

FIG. 4 illustrates how the core vocabulary is supplemented and associated within the conceptual groupings that form the semantic structure. The computer program generates a random sample of descriptions from the database for each term in the core vocabulary developed in FIG. 2 that is representative of the population at a 95% confidence level. The citations for each term are presented to the domain expert along with the list of primary conceptual groupings developed in FIG. 3. The domain expert is asked to assign each term to a primary conceptual grouping. The computer program then records all of the terms and their conceptual grouping assignments in the Lexicon file. The computer program then prepares a listing of all core vocabulary terms within each conceptual grouping, The listing is presented to the domain expert who is requested to identify any additional terms that are appropriate to each conceptual grouping, including synonyms and common misnomers [i,e. “dungarees” and “jeans” to the group of “clothing types”]. These additional terms are recorded in the Lexicon file with their conceptual grouping assignments.

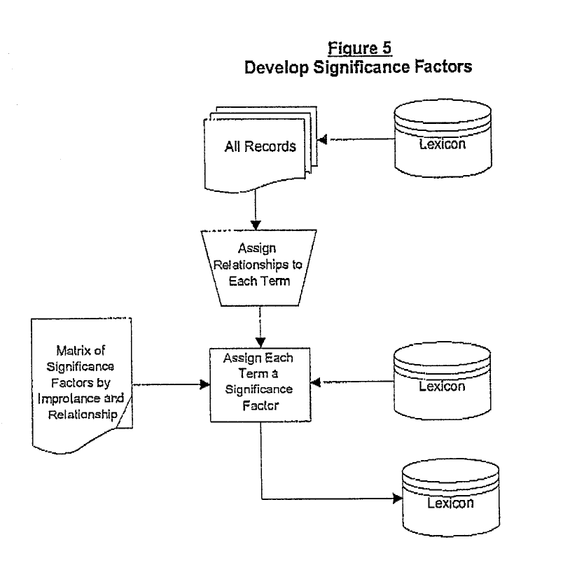

FIG. 5 illustrates how the invention captures the contextual significance of the usage of each term. The computer program prepares a record for each term that starts with it as the records “primary term” and then lists all of the other terms in the Lexicon file that have the same conceptual grouping assignment. The domain expert is then presented with the primary term and its associated terms and asked to identify each associated term's relationship to the primary term [i.e. synonym, misnomer, similar term, no relationship, anonym]. These contextual relationships are recorded in the Lexicon file. The computer program then determines a significance factor for each term in each record based on the importance of the conceptual grouping and the relationship of the term in context to the primary term. These factors are stored in a two-dimensional matrix “look up” table.

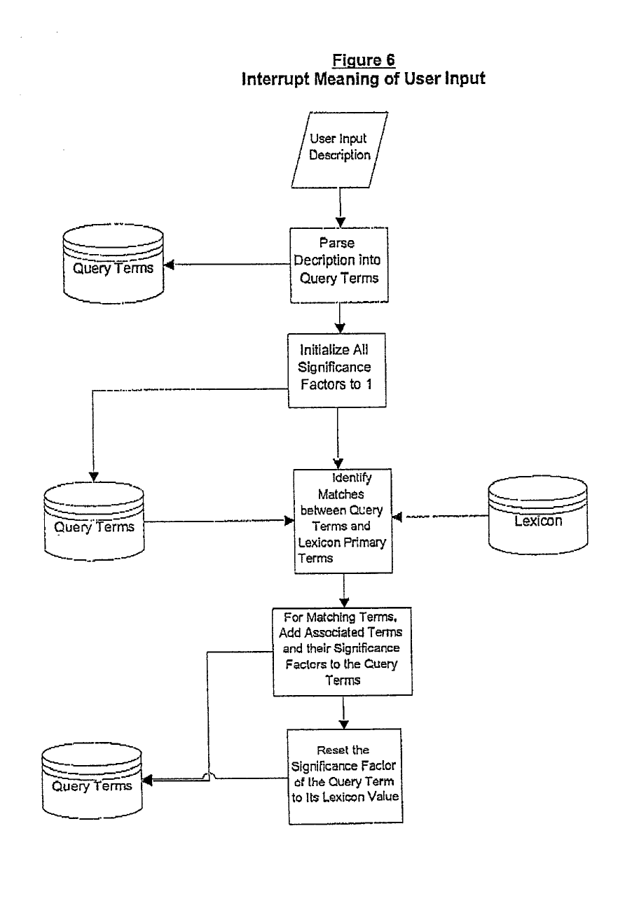

FIG. 6 illustrates how the invention interrupts the meaning of the user request. The user enters one or more words that describe the entries they are interested in. The computer program parses the input into individual query terms and assigns each a significance factor of 1.0. The computer program then compares each query term with each primary term in the Lexicon file using a character string matching function. When an exact match is found, the significance factor of the inputted query term is reset to the value of the primary term in the Lexicon file. All terms associated with the primary term are then added to the list of query terms along with their significance factors. This process is repeated for every query term from the user request. When complete, the set of query terms and their significance factors represent the meaning of the user request in the semantic structure of the database.

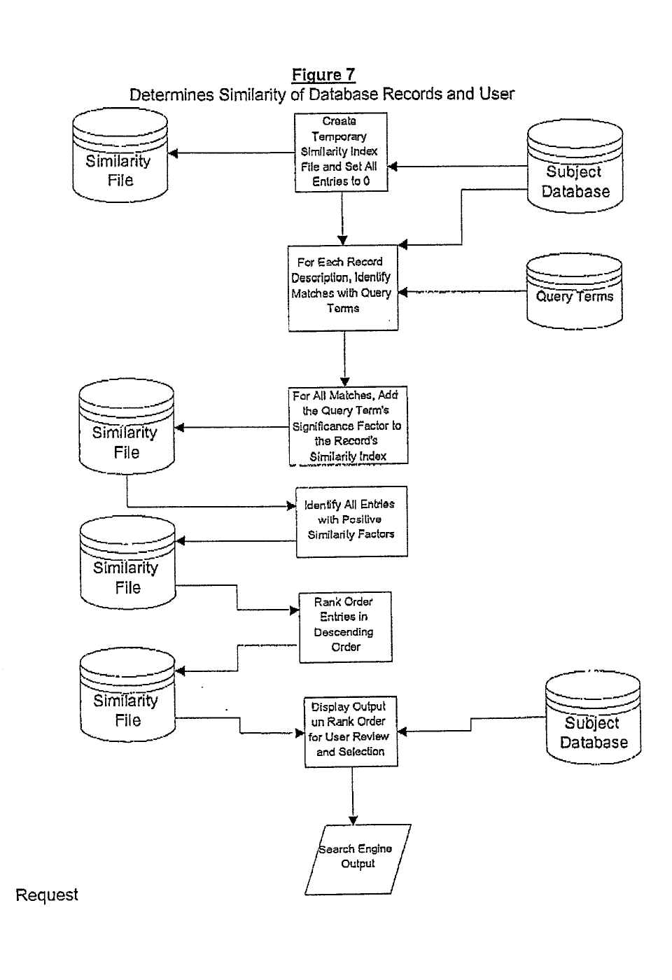

FIG. 7 illustrates how the invention determines the similarity of the content a database record and the meaning of a user request. The computer program creates a similarity index for each record in the database and sets all of them to 0.0. The computer program then takes each query term and executes a character string comparison with each word in the first database description. If there is an exact match, the query term's significance factor is added to the database record's similarity index. If an exact match is not found, no change is made to the database record's similarity index. The process is repeated with the next query term until all query terms have been compared to the database record's description, When all query terms have been compared with the database record description, the computer program repeats the entire procedure on the next database record. In this manner, the similarity between the content of each database record and the meaning of the user request is captured in a quantative index. The significance factors developed in FIG. 6 were designed so that high values of the similarity index represent close matches and negative values-indicate that database record and the meaning of the user request are dissimilar in a meaningful way. [i.e. if the user requested “plate”, “platter” would have a high similarity index but “bowl” would have a negative value]. The computer program then sorts the records with positive similarity indexes in descending order for presentation for subjective review by the user.

1. In a computer system that implements a search engine to identify descriptions that match a set of key words, a method of enhancing user input to improve discovery, the method comprising the computer-implemented steps of:
a. Analyzing the terminology usage within the database to identify the core vocabulary
b. assisting in the identification of the predominate semantic structure
c. recording the conceptual assignment, supplementary terms and contextual significance of the core vocabulary;
d. receiving a search query from a user, the search query including at least one query term;
e. supplementing the search query with semantic data associated with the input query term(s);
f. identifying database descriptions that are conceptually similar to the input;
g. ranking identified description based on their similarity to the input;
h. Presenting the similar entries to the user for subjective selection.

2. The method of claim 1, wherein step (c) comprises generating a data structure which links key terms to other terms related to them within the context of the database as well as their contextual significance, based on their predominate semantic usage, and step (e) composes accessing the data structure to add the related terms and their contextual significance to the query criteria.

3. The method of claim 1, wherein step (a) comprises the sub-steps of:
(a1) creating a frequency distribution analysis of the words used in the database descriptions; and
(a2) rank ordering the words in descending order of usage; and
(a3) identifying the word where the second derivative of individual usage with respect to the cumulative number of words analyzed reaches its first local minimum; and
(a4) identifying the set of words, from most used to the word identified in (a3), which compose the core vocabulary of the database.

4. The method of claim 1, step (b) comprises the sub-steps of:
(b1) presenting a statistically valid sample of descriptions that contain the word for manual review; and
(b2) presenting a template of common conceptual groupings for manual review; and
(b3) manually identifying and recording a list of the conceptual groupings that predominate the semantic structure of the database descriptions and assigning an importance level to each grouping.

5. The method of claim 1, step (c) comprises the sub-steps of:
(c1) for each term in the core vocabulary, presenting a statistically valid sample of its citations for manual review; and
(c2) presenting the list of conceptual groupings developed in step (a7) for manual review, and
(c3) manually assigning the term to a conceptual grouping.

6. The method of claim 1, step (c) further comprising the sub-steps of:
(c4) preparing a lexicon for the database composed of a record of each term in the core vocabulary, its conceptual grouping as well as its importance category; and
(c5) appending to each record all other terms in the lexicon that share the primary term's conceptual grouping; and
(c6) manually reviewing each entry and judgmentally adding appropriate synonyms, anonyms and common misnomers; and
(c7) manually assigning each term in each entry a relationship to the primary term; and
(c8) assigning a significance factor to each term of each entry based on a lookup table matrix of grouping importance and term relationship.

7. The method of claim 1, wherein step (f) comprises generating a similarity index for each database description based on the query term(s) and their associated semantic data.

8. The method of claim 7, wherein step (f) comprises the sub-steps of:
(f1) creating a similarity index which is initially set at zero; and
(f2) for each term in the expanded query criteria, comparing it to the words in the database description: and
(f3) in the event of a word match, indexing the entry's similarity factor by the term's significance factor.

9. The method of claim 1, wherein step (f) further comprises the sub-steps of:
(f4) identifying for output entries that have a positive similarity index.

10. The method of claim 1, wherein step (g) comprises the sub-steps of:
(g1) rank ordering entries prepared for output based on their similarity indices
(g2) presenting output data to the user in descending order of similarity index.
